(19) United States
(12) Patent Application Publication
(10) Pub. No.: US 2009/0095120 A1
(43) Pub. Date: Apr. 16, 2009

(54) Structure of Electronic Accelerator Pedal With Hysteresis and Sensor

(76) Inventor: Kyeong Bae Choi, Daejon-City (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 11/945,517

(22) Filed: Nov. 27, 2007

(30) Foreign Application Priority Data
Oct. 12, 2007 (KR) 10-2007-0103154
Oct. 12, 2007 (KR) 10-2007-0103155

(51) Int. Cl. G05G 1/30

(52) U.S. Cl. 74/513

(57) ABSTRACT

There is provided a structure of an electronic accelerator pedal with hysteresis and a sensor, which uses hysteresis, comprising: a pedal to be pushed by a driver's foot; a hinge unit in which a sensor is installed for sensing a rotation angle of the pedal at the symmetrical outside of a body to the inside of another side of the body in which the pedal is pivotably formed and for sending an electrical signal to a controller; a pressing plate with one side to be connected to a spring positioned on a supporting plate and the other side to be pivotably hinged to the body, wherein the supporting plate is formed by extending one side of the pedal through the hinge unit and the body and a clearance space are formed above the spring; and a contact plate to contact with one side end of the pressing plate and to be pressed when the pressing plate is pivoted by the spring, for pressurizing the hinge unit of the pedal.

Further, the present invention relates to a structure of an electronic accelerator pedal with hysteresis and a sensor, which uses hysteresis, comprising: a pedal to be pushed by a driver's foot; a hinge unit in which a sensor is installed for sensing a rotation angle of the pedal at the symmetrical outside of a body to the inside of another side of the body in which the pedal is pivotably formed and for sending an electrical signal to a controller; a pressing plate with one side to be connected to a top side of a supporting plate formed by extending one side of the pedal through the hinge unit and the other side to be pivotably hinged to the body, wherein a spring is connected to a top side of the pressing plate; and a contact plate to contact with one side end of the pressing plate and to be pressed when the pressing plate is pivoted by the spring, for pressurizing the hinge unit of the pedal.

### CROSS-REFERENCE TO RELATED APPLICATIONS

This application claims the benefit of Korean Patent Application No. 10-2007-0103154 filed Oct. 12, 2007 and Korean Patent Application No. 10-2007-0103155 filed Oct. 12, 2007, the disclosures of which are hereby incorporated herein by reference in their entireties.

### TECHNICAL FIELD

The present invention relates to a structure of an electronic accelerator pedal with hysteresis and a sensor and, more particularly, to a structure of an electronic accelerator pedal with hysteresis and a sensor, which uses hysteresis, comprising: a pedal to be pushed by a driver's foot; a hinge unit which is formed with the pedal to pivotably rotate inside of a body at its (hinge unit) one (shaft) end and, is installed with a sensor for sensing a rotation angle of the pedal and sending an electrical signal to a controller at its (hinge unit) other (shaft) end; a pressing plate with one side to be connected to a spring positioned on a supporting plate and the other side to be pivotably hinged (a) to the body, wherein the supporting plate is formed by extending one side of the pedal through the hinge unit and a clearance space from the body is formed above the spring; and a contact plate to contact with another end of the pressing plate to press the hinge unit of the pedal when the pressing plate is rotated by the spring

Further, the present invention relates to a structure of an electronic accelerator pedal with hysteresis and a sensor and, more particularly, to a structure of an electronic accelerator pedal with hysteresis and a sensor, which uses hysteresis, comprising: a pedal to be pushed by a driver's foot; a hinge unit in which a sensor is installed for sensing a rotation angle of the pedal at the symmetrical outside of a body to the inside of another side of the body in which the pedal is pivotably formed and for sending an electrical signal to a controller; a pressing plate with one end to be connected on a supporting plate to be pivotably hinged (c) to the body, wherein the supporting plate is formed by extending one side of the pedal through the hinge unit and a spring is connected to a top side of the pressing plate; and a contact plate to contact with one side end of the pressing plate and to be pressed when the pressing plate is pivoted by the spring, for pressurizing the hinge unit of the pedal.

### BACKGROUND ART

Generally, an accelerator pedal for an automobile has the function of controlling the extent of air, fuel or power of an intake system, depending on a pedal pushing force of a driver.

A conventional accelerator pedal has the constitution in which a pedal pushing force of a foot is transmitted to an engine by a link and a cable and has the operation process in which the link and cable are pulled by the pedal pushing force of the foot of a driver. In this cable system, upon use for a long time, the cable is likely to be worn away or loose and accordingly, fuel supply and power systems are not accurately controlled. Further, the structure is complicate.

Examples of conventional accelerator pedals to solve the aforementioned problems include an pedal module in which a pedal and a sensor are formed in the same shaft, another pedal module in the mechanism in which a lever connected to a pedal transmits a rotation angle to a lever connected to a sensor, and other modules.

In the aforementioned prior art, the rotation of the pedal is output to a controller through the sensor, to control the supply of fuel and air and the power of an engine.

In these conventional accelerator pedal modules, when a driver drives on a bad road with the surface is very uneven, the driver unconsciously repeats pedaling and keeping her/his foot off the accelerator pedal. In this case, the car stumbles. Thus, the conventional pedal modules use a driving roller or installs a friction plate at a foot bearing, to prevent the car from stumbling.

### DISCLOSURE

### Technical Problem

As described above, since the conventional pedal module has the complicate structure, the manufacturing unit cost is expensive and it is difficult to be assembled and installed. Moreover, in the conventional pedal module in which the friction plate is installed at the foot bearing, the manufacturing process is complicate and it is difficult to cope with different pedal pushing forces.

Therefore, the present invention has been made to solve the above problems, and it is an aspect of the present invention to provide a structure of an electronic accelerator pedal with hysteresis and a sensor, which has a frictional force between a contact unit and a hinge unit, so that a driver can pedal or keep her/his foot off the accelerator pedal, with a less force, and therefore, (s)he feel less tired upon long-time driving.

### Technical Solution

In accordance with an embodiment of the present invention, the above and other aspects can be accomplished by a structure of an electronic accelerator pedal with hysteresis and a sensor, which uses hysteresis, comprising: a pedal to be pushed by a driver's foot; a hinge unit in which a sensor is installed for sensing a rotation angle of the pedal at the symmetrical outside of a body to the inside of another side of the body in which the pedal is pivotably formed and for sending an electrical signal to a controller; a pressing plate with one side to be connected to a spring positioned on a supporting plate and the other side to be pivotably hinged to the body, wherein the supporting plate is formed by extending one side of the pedal through the hinge unit and the body and a clearance space are formed above the spring; and a contact plate to contact with one side end of the pressing plate and to be pressed when the pressing plate is pivoted by the spring, for pressurizing the hinge unit of the pedal.

In accordance with another embodiment of the present invention, the above and other aspects can be accomplished by a structure of an electronic accelerator pedal with hysteresis and a sensor, which uses hysteresis, comprising: a pedal to be pushed by a driver's foot; a hinge unit in which a sensor is installed for sensing a rotation angle of the pedal at the symmetrical outside of a body to the inside of another side of the body in which the pedal is pivotably formed and for sending an electrical signal to a controller; a pressing plate with one side to be connected to a top side of a supporting plate formed by extending one side of the pedal through the hinge unit and the other side to be pivotably hinged to the body, wherein a spring is connected to a top side of the pressing plate; and a contact plate to contact with one side end of the pressing plate and to be pressed when the pressing plate is pivoted by the spring, for pressurizing the hinge unit of the pedal.

### Advantageous Effects

In accordance with the structure of the electronic accelerator pedal with the hysteresis and the sensor of the present invention, since a driver pedals or keeps her/his foot off the accelerator pedal, with a less force, by the frictional force between the contact unit and the hinge unit, (s)he feel less tired upon long-time driving.

### DESCRIPTION OF DRAWINGS

These and other aspects and advantages of the present invention will become apparent and more readily appreciated from the following description of the embodiments, taken in conjunction with the accompanying drawings, in which:

FIG. 1 is a front sectional view illustrating the whole structure of an electronic accelerator pedal with hysteresis and a sensor, in which a pressing plate is formed at an upper position, according to an embodiment of the present invention;

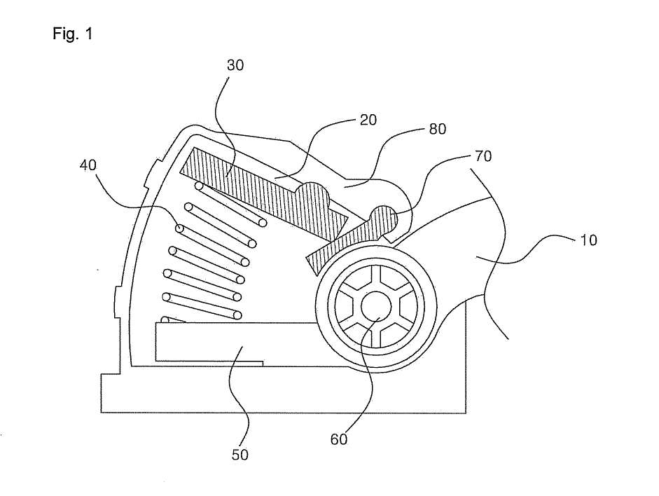

FIG. 2 is a front sectional view illustrating the whole structure of an electronic accelerator pedal with hysteresis and a sensor, in which a pressing plate is formed at a lower position, according to an embodiment of the present invention;

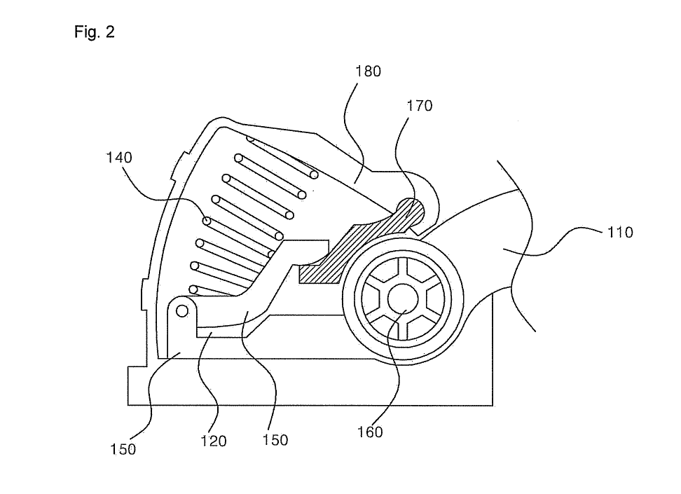

FIG. 3 is a disassembled perspective view of a pedal and a sensor to be connected to the outside of the pedal in the structure according to the embodiments of the present invention;

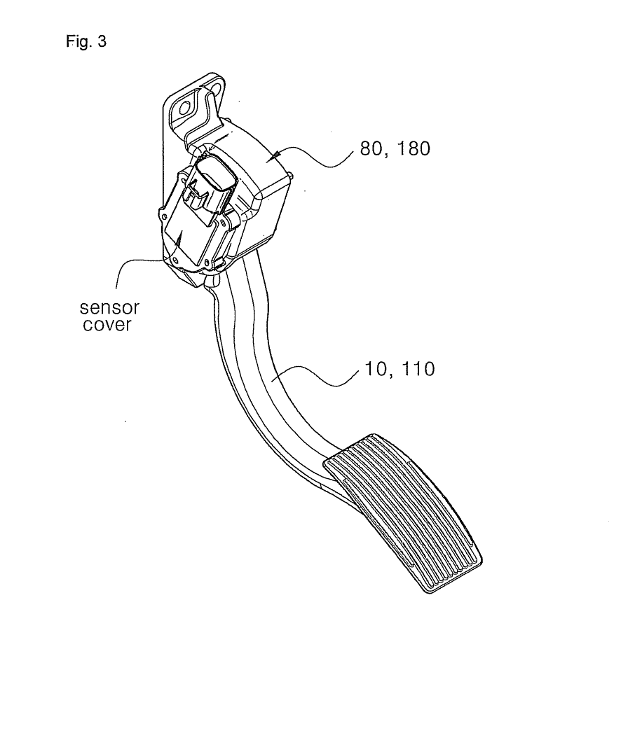

FIG. 4 is a dissembled perspective view of a sensor part to be connected to the outside of the pedal and a perspective view of the pedal in the structure according to the embodiments of the present invention;

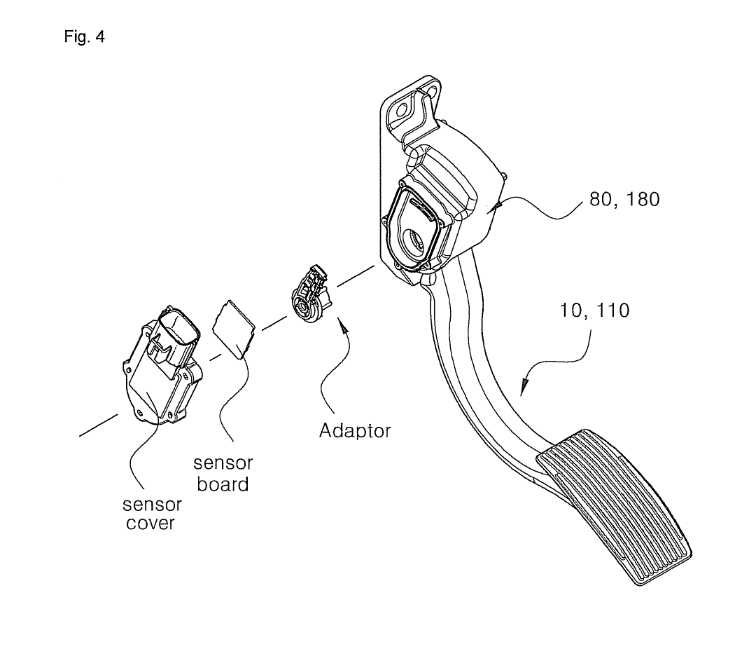

FIG. 5 is a dissembled perspective view of a contact type sensor to be connected to the outside of the pedal in the structure according to the embodiments of the present invention;

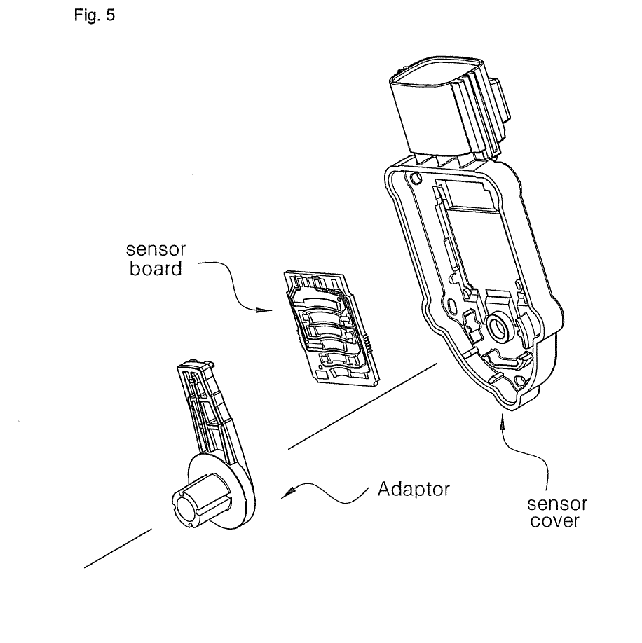

FIG. 6 is an assembled perspective view of an independent type sensor to be connected to the outside of the pedal in the structure according to the embodiments of the present invention; and

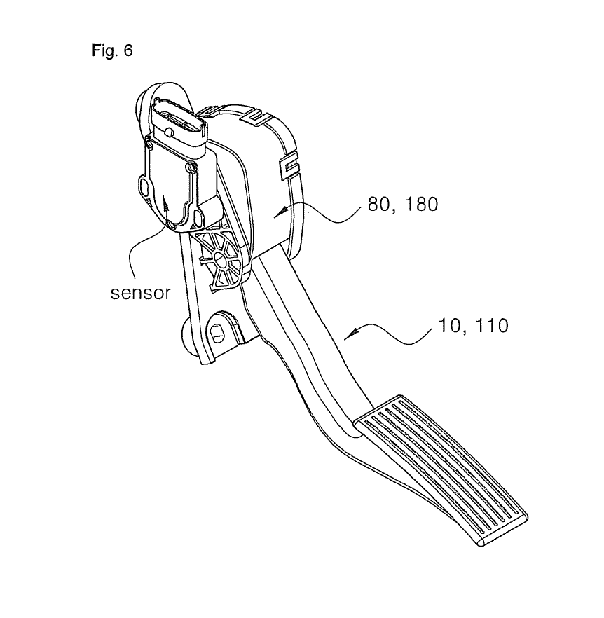

FIG. 7 is a structural view to assemble the independent type sensor to be connected to the outside of the pedal in the structure according to the embodiments of the present invention.

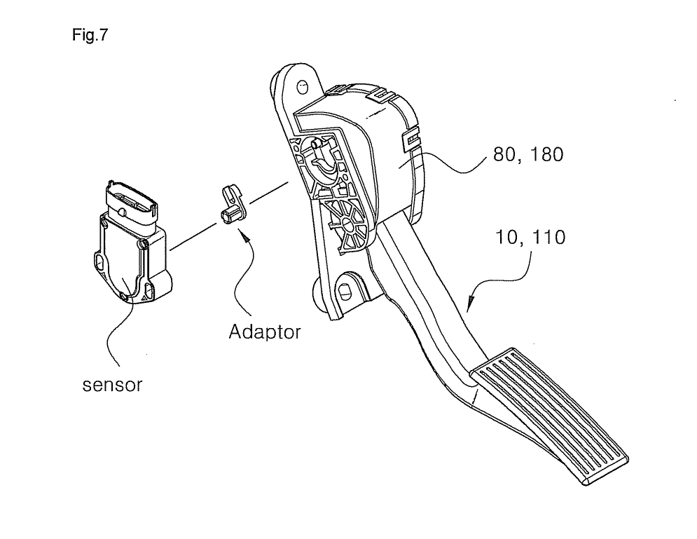

### BEST MODE

### Mode of Invention

Hereinafter, embodiments of the present invention will be described in detail with reference to the accompanying drawings.

In an embodiment of the present invention, a structure of an electronic accelerator pedal with hysteresis and a sensor, which uses hysteresis, comprises: a pedal 10 to be pushed by a driver's foot; a hinge unit 60 in which a sensor is installed for sensing a rotation angle of the pedal 10 at the symmetrical outside of a body 80 to the inside of another side of the body 80 in which the pedal 10 is pivotably formed and for sending an electrical signal to a controller; a pressing plate 30 with one side to be connected to a spring 40 positioned on a supporting plate 50 and the other side to be pivotably hinged to the body 80, wherein the supporting plate 50 is formed by extending one side of the pedal 10 through the hinge unit 60 and the body 80 and a clearance space 20 are formed above the spring 40; and a contact plate 70 to contact with one side end of the pressing plate 30 and to be pressed when the pressing plate 30 is pivoted by the spring 40, for pressurizing the hinge unit 60 of the pedal 10.

When a driver pushes the pedal 10 to pivotably rotate the supporting plate 50 around the hinge unit 60, the spring 40 is pressed to push the pressing plate 30 upward. The pressing plate 30 pivots around the hinge (a) upward to the clearance space 20, so that the contact plate 70 connected to the one end of the pressing plate 30 is pressed to be in contact with the hinge unit 60.

Further, the contact plate 70 is formed in the same shape as a contact surface of the hinge unit 60, so that a frictional force greatly acts on the contact surface of the contact plate 70 and the hinge unit 60.

The structure of the electronic accelerator pedal according to the embodiment of the present invention will be described, in detail, below:

The hinge unit 60 to be connected to the body 80 by a hinge is formed inwardly by a predetermined length and at a predetermined width, at an end of the pedal 10 to be pushed by a driver. The supporting plate 50 formed at the one end of the pedal 10 is extended from the hinge unit 60.

The top side of the supporting plate 50 is connected to the spring 40. The clearance space 20 from the body 80 is formed above the spring 40. The other side of the pressing plate 30 connected to the body 80 by the hinge (a) contacts the spring 40. When the pressing plate 30 pivots, the contact plate 70 which one end is hinge (b) coupled to the body 80 is pressed by the other side end of the pressing plate 30 and contacted with the hinge unit 60.

In the above-described structure, when a driver pushes the pedal 10, the supporting plate 50 extended from the hinge unit 60 pivots around the hinge unit 60 and moves upward to press the spring 40. Then, the spring 40 presses the pressing plate 30 positioned above the spring 40, so that the pressing plate 30 pivots and accordingly, the contact plate 70 contacting with the other side end of the pressing plate 30 is pressed to contact with the hinge unit 60, to generate friction.

In another embodiment, a structure of an electronic accelerator pedal with hysteresis and a sensor, which uses hysteresis, comprises: a pedal 110 to be pushed by a driver's foot; a hinge unit 160 in which a sensor is installed for sensing a rotation angle of the pedal 110 at the symmetrical outside of a body 180 to the inside of another side of the body 180 in which the pedal 110 is pivotably formed and for sending an electrical signal to a controller; a pressing plate 130 with one side to be connected to a top side of a supporting plate 150 formed by extending one side of the pedal 110 through the hinge unit 160 and the other side to be pivotably hinged to the body 180, wherein a spring 140 is connected to a top side of the pressing plate 130; and a contact plate 170 to contact with one side end of the pressing plate 130 and to be pressed when the pressing plate 130 is pivoted by the spring 140, for pressurizing the hinge unit 160 of the pedal 110.

When a driver pushes the pedal 110 so that the supporting plate 150 pivots around the hinge unit 160, the pressing plate 130, which one end is connected to the supporting plate 150 by the hinge (c), is pushed downward by the spring 140 positioned on the pressing plate 130. The pressing plate 130 pivots around the hinge downward to the clearance space 120 and presses the contact plate 170 contacting with the other end of the pressing plate 130 so as to be in contact with the hinge unit 160 of the pedal 100.

Further, the contact plate 170 is formed in the same shape as a contact surface of the hinge unit 160, so that a frictional force greatly acts on the surface of the contact plate 170 to contact with the hinge unit 160.

The structure of the electronic accelerator pedal according to the embodiment of the present invention will be described, in detail, below.

The hinge unit 160 to be connected to the body 180 by a hinge is formed inwardly by a predetermined length and at a predetermined width, at an end of the pedal 110 to be pushed by a driver. The supporting plate 150 formed at a side end of the pedal 110 is extended from the hinge unit 160. On the supporting plate 150, one end of the pressing plate 130 is connected to the supporting plate 150 by the hinge (c). The spring 140 is connected to the top side of the pressing plate 130, so that when the supporting plate 150 pivots around the hinge unit 160 upward, the pressing plate 130 is rotated by the spring 140.

When the pressing plate 130 pivots, the contact plate 170 to contact with the hinge unit 160 is pressed by the other end of the pressing plate 130, so that the other end of the contact plate 170 connected to the body 180 by the hinge (d) contacts with the hinge unit 160.

In the above-described structure, when a driver pushes the pedal 110, the supporting plate 150 formed by extending from the hinge unit 160 pivots around the hinge unit 160 and moves upward, so that the spring 140 installed on the top side of the pressing plate 130 pressurizes the pressing plate 130 connected at one end of the supporting plate 150 by the hinge (c) and accordingly, the pressing plate 130 is pressed to pivot. Thereby, the contact plate 170 in contact with the other end of the pressing plate 130 is pressed to contact with the hinge unit 60, to generate friction.

Further, in the each embodiment, the sensor is connected at the outside of the external hinge unit 60 or 160 of the body 80 or 180, by connecting an adaptor which is operatively and pivotably connected to the hinge unit 60 or 160 at the outside the body 80 or 180, connecting a sensor board to one side of the adaptor so as to measure a rotation angle of the adaptor being pivoted, and connecting a sensor cover to one side of the sensor board so as to cover the sensor board and the adaptor to be connected to the body 80 or 180.

What is claimed is:

1. A structure of an electronic accelerator pedal with hysteresis and a sensor, which uses hysteresis, comprising:
a pedal (10) to be pushed by a driver's foot;
a hinge unit (60) in which a sensor is installed for sensing a rotation angle of the pedal (10) at the symmetrical outside of a body (80) to the inside of another side of the body (80) in which the pedal (10) is pivotably formed and for sending an electrical signal to a controller;
a pressing plate (30) with one side to be connected to a spring (40) positioned on a supporting plate (50) and the other side to be pivotably hinged to the body (80), wherein the supporting plate (50) is formed by extending one side of the pedal (10) through the hinge unit (60) and the body (80) and a clearance space (20) are formed above the spring (40); and
a contact plate (70) to contact with one side end of the pressing plate (30) and to be pressed when the pressing plate (30) is pivoted by the spring (40), for pressurizing the hinge unit (60) of the pedal (10).

2. The structure according to claim 1, wherein, when the driver pushes the pedal (10) so that the supporting plate (50) pivots around the hinge unit (60) and the spring (40) is pressed, the hinge unit (60) pushes the pressing plate (30) upward and the pressing plate (30) pivots around a hinge upward by the clearance space (20), to press the contact plate (70) contacting with the one side end of the pressing plate (30) so as to contact with the hinge unit (60) of the pedal (10).

3. The structure according to claim 1, wherein the contact plate (70) is formed in the same shape as a contact surface of the hinge unit (60), so that a frictional force greatly acts on the contact surface of the contact plate (70) and the hinge unit (60).

4. A structure of an electronic accelerator pedal with hysteresis and a sensor, which uses hysteresis, comprises:
a pedal (110) to be pushed by a driver's foot;
a hinge unit (160) in which a sensor is installed for sensing a rotation angle of the pedal (110) at the symmetrical outside of a body (180) to the inside of another side of the body (180) in which the pedal (110) is pivotably formed and for sending an electrical signal to a controller;
a pressing plate (130) with one side to be connected to a top side of a supporting plate (150) formed by extending one side of the pedal (110) through the hinge unit (160) and the other side to be pivotably hinged to the body (180), wherein a spring (140) is connected to a top side of the pressing plate (130); and
a contact plate (170) to contact with one side end of the pressing plate (130) and to be pressed when the pressing plate (130) is pivoted by the spring (140), for pressurizing the hinge unit (160) of the pedal (110).

5. The structure according to claim 4, wherein, when the driver pushes the pedal (110) so that the supporting plate (150) pivots around the hinge unit (160), the hinge unit (160) pushes the pressing plate (130), which is connected to the one side of the supporting plate (150) by a hinge, downward by the spring (140) installed on the top side of the pressing plate (130), the pressing plate (130) pivots around the hinge downward by a clearance space and presses the contact plate (170) contacting with the other side end of the pressing plate (130) so as to contact to the hinge unit (160) of the pedal (110).

6. The structure according to claim 4, wherein the contact plate (170) is formed in the same shape as a contact surface of the hinge unit (160), so that a frictional force greatly acts on the contact surface of the contact plate (170) and the hinge unit (160).
